(19) United States
(12) Patent Application Publication
(10) Pub. No.: US 2010/0014521 A1
(43) Pub. Date: Jan. 21, 2010

(54) ADDRESS CONVERSION DEVICE AND ADDRESS CONVERSION METHOD

(75) Inventors: Tomofumi Tamura, Kanagawa (JP); Yuji Hashimoto, Kanagawa (JP); Satoshi Iino, Kanagawa (JP); Kenichiro Iida, Kanagawa (JP); Atsushi Kamikura, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: MATSUSHITA ELECTRIC INDUSTRIAL CO., LTD., OSAKA (JP)

(21) Appl. No.: 11/722,324

(22) PCT Filed: Dec. 15, 2005
(86) PCT No.: PCT/JP05/23030

§ 371 Date: Jun. 20, 2007

(30) Foreign Application Priority Data
Dec. 22, 2004 (JP) 2004-372328

(51) Int. Cl. H04L 12/56

(52) U.S. Cl. 370/392

(57) ABSTRACT

It is possible to perform access from a global network side to a private network side so as to realize mutual communication between the global network and the private network while maintaining security. A table setting unit (307) decides a correspondence between a private IP address and a global IP address and registers it in an address conversion table (310). The address conversion table (310) holds the private IP address and the global IP address while correlating them to each other.

### TECHNICAL FIELD

The present invention relates to an address transfer apparatus and an address transfer method, and more particularly, to an address transfer apparatus and an address transfer method at a gateway between a global network and a private network or the like.

### BACKGROUND ART

Currently, a general network is constructed of a global network made up of global IP addresses usable on the Internet and a private network made up of an address space which is different from the global network such as a home network or corporate network. On the private network, private IP addresses which are not used on the global network are freely used.

When a communication is carried out across the global network and the private network in such a network configuration, an address transfer (Network Address Transfer: NAT) is required whereby private IP addresses and global IP addresses are mutually transferred on a boundary between the global network and the private network. This allows, for example, a host in the private network which is not assigned any global IP address to also access the global network.

In order to realize the above described NAT, for example, a method of arranging a proxy server on the boundary between the networks may be used. The proxy server is a relay apparatus, which terminates input data at an application layer level, then assigns the IP address of the proxy server to an IP packet and transfers it to the destination. In the case of access, for example, from a host in the private network to a Web server in the global network, an HTTP protocol is used between the host and the Web server and an HTTP proxy server is arranged on the network boundary. The HTTP proxy server terminates an HTTP message from the host at an application layer level. The HTTP proxy server then sets the global IP address of the HTTP proxy server in the IP packet and transfers it to the Web server. The reverse of the above described processing is performed when making access from the host in the global network to the Web server in the private network.

However, in the case of NAT by the above described proxy server, application layer level relays are performed on all IP packets, and therefore the load on the proxy server increases and it is not possible to realize NAT on applications which are not targets of the proxy server.

Therefore, a technique disclosed, for example, in Patent Document 1 is considered as a method of realizing NAT from the private network to the global network without using any proxy server.

Hereinafter, an overview of the technique disclosed in Patent Document 1 will be explained with reference to FIG. 1 and FIG. 2. The network disclosed in Patent Document 1 is mainly made up of private network 10, global network 20 and DMZ (DeMilitarized Zone: demilitarized zone) 30 as shown in FIG. 1. In FIG. 1, “PA1” to “PA5” denote private IP addresses and “GA1” to “GA5” denote global IP addresses.

Private network 10 includes host 10 a having domain name “a.private.com” (private IP address “PA3”), DNS (Domain Name System) server 10b that manages the domain name of the host in private network 10 (private IP address “PA2”) and L2-SW10c. Further, global network 20 includes IP public network 20a, host 20b (Global IP address “GA4”) having domain name “a.global.com” and DNS server 20c (Global IP address “GA5”) that manages the domain name of the host in global network 20.

Furthermore, DMZ 30 accessible from both private network 10 and global network 20 includes address transfer/filtering apparatus 30a (Private IP address “PA1” and global IP address “GA1”), DNS server 30b (Global IP address “GA2”) that performs a name resolution of private network 10 or global network 20, router 30c (global IP address “GA3”) that transfer an IP packet to the global network and L2-SW 30d.

In the above described network configuration, access from host 10a in private network 10 to host 20b in global network 20 is performed as shown, for example, in FIG. 2.

That is, first, host 10a transmits a request for a name resolution (DNS query) to DNS server 10b about domain name “a.global.com” of host 20b. Since DNS server 10b has no domain name “a.global.com” registered, a recursive query is sent to DNS server 30b in DMZ 30. In that case, address transfer/filtering apparatus 30a converts a sender address and a destination address from the private IP addresses to global IP addresses. DNS server 20c which has received the recursive query from DNS server 30b through router 30c and IP public network 20a searches “a.global.com” from the name-address table stored in DNS server 20c and acquires global IP address “GA4” of host 20b (name resolution). DNS server 20c transfers the acquired global IP address “GA4” to DNS server 30b.

DNS server 30b then associates private IP address “PA5” which is unused in the address management table stored in DNS server 30b with global IP address “GA4” and transmits an address registration request to address transfer/filtering apparatus 30a. Address transfer/filtering apparatus 30a registers private IP address “PA5” and global IP address “GA4” in the address transfer table stored in address transfer/filtering apparatus 30a and reports completion of address registration to DNS server 30b. DNS server 30b then transmits private IP address “PA5” to DNS server 10b in private network 10 through address transfer/filtering apparatus 30a.

DNS server 10b transfers a DNS reply to host 10a and host 10a starts access to host 20b. That is, host 10a transmits an IP packet to address transfer/filtering apparatus 30a using reported private IP address “PA5” as a destination address. Address transfer/filtering apparatus 30a converts private IP address “PA5” of the destination address to global IP address “GA4” based on the address transfer table. Furthermore, address transfer/filtering apparatus 30a generates port mapping corresponding to sender address “PA3”, registers it in the address transfer table and converts the sender address/port to global IP address/port which corresponds to the mapping. Address transfer/filtering apparatus 30a transmits the IP packet for which NAT has been performed as described above to host 20b of global network 20. In the subsequent communications from host 10a of private network 10 to host 20b of global network 20, address transfer/filtering apparatus 30a will implement Twice-NAT whereby both the sender address and the destination address are converted based on the address transfer table.

In this way, access from the private network to the global network is made possible by providing a DMZ between the private network and the global network and implementing Twice-NAT without using any proxy server such as an HTTP proxy server or SIP proxy server.

### Patent Document 1: Japanese Patent Application Laid-Open No. 2004-304235

### DISCLOSURE OF THE INVENTION

### Problems to be Solution by the Invention

However, there is a problem that access from the host of the global network to the host of the private network is refused in the above described conventional technique. This problem will be explained by taking the case with the network configuration in FIG. 1 as an example again. FIG. 3 is a sequence diagram showing an example of access from host 20b in global network 20 to host 10a in private network 10 in the network configuration in FIG. 1.

In order to perform a name resolution of domain name “a.private.com” of host 10a, host 20b in global network 20 transmits a DNS query to DNS server 20c registered beforehand. Since “a.private.com” is not registered in the name-address table stored in DNS server 20c, DNS server 20c sends a recursive query to DNS server 30b in DMZ 30. Though DNS server 30b knows that “a. private.com” is registered in DNS server 10b in private network 10, it rejects a name resolution because of the name query from global network 20 and transfers an error to DNS server 20c. DNS server 20c then transfers an error to host 20b. Therefore, host 20b in global network 20 cannot access host 10a in private network 10.

Furthermore, if an arrangement is made to avoid any rejection to a name resolution from global network 20, access from global network 20 to private network 10 may be made possible, but this will allow a third party to easily intrude private network 10 and compromise security.

It is an object of the present invention to provide an address transfer apparatus and an address transfer method capable of allowing a global network to access a private network while maintaining security and realizing intercommunication between the global network and the private network.

### Means for Solving the Problem

The address transfer apparatus according to the present invention is an address transfer apparatus provided between a first network in which a packet destination is included and a second network in which a packet sender is included and adopts a configuration including: a setting section that sets an address of the packet destination in the above described first network in association with a temporary address in the above described second network; a first transmission section that transmits the set temporary address to the above described packet sender; a conversion section that converts the destination address and the sender address of the packet transmitted from the packet sender to addresses in the above described first network; and a second transmission section that transmits the packet after the address transfer to the above described packet destination.

The address transfer method according to the present invention is an address transfer method between a first network in which a packet destination is included and a second network in which a packet sender is included, configured to include: setting an address of the packet destination in the above described first network in association with a temporary address in the above described second network; transmitting the set temporary address to the above described packet sender; converting the destination address and the sender address of the packet transmitted from the packet sender to addresses in the above described first network; and transmitting the packet after the address transfer to the above described packet destination.

According to the above, a temporary address is associated with the packet destination, the sender address and the destination address of a packet transmitted from the packet sender to a temporary address are converted to addresses in the first network and then transmitted to the packet destination, and therefore it is possible to conceal the packet sender address from the packet destination and also conceal the address of the packet destination from the packet sender. Therefore, it is possible to allow access from the global network to the private network while maintaining security and realize intercommunication between the global network and the private network.

### ADVANTAGEOUS EFFECT OF THE INVENTION

According to the present invention, it is possible to allow access from the global network side to the private network side while maintaining security and realize intercommunication between the global network and the private network.

### BRIEF DESCRIPTION OF DRAWINGS

FIG. 1 illustrates an example of a conventional network configuration;

FIG. 2 is a sequence diagram showing an example of access between the private network and the global network in the conventional network configuration;

FIG. 3 is a sequence diagram showing another example of access between the private network and the global network in the conventional network configuration;

FIG. 4 illustrates an example of a network configuration according to Embodiment 1 of the present invention;

FIG. 5 is a block diagram showing the configuration of the gateway apparatus according to Embodiment 1;

FIG. 6 illustrates an example of the name-address table according to Embodiment 1;

FIG. 7 illustrates an example of the private IP address management table according to Embodiment 1;

FIG. 8 illustrates an example of the global IP address management table according to Embodiment 1;

FIG. 9 illustrates an example of the address transfer table according to Embodiment 1;

FIG. 10 is a flow chart showing processing at the table setting section according to Embodiment 1;

FIG. 11 is a flow chart showing processing at the Twice-NAT processing section according to Embodiment 1;

FIG. 12 is a sequence diagram showing an example of access between the private network and the global network according to Embodiment 1;

FIG. 13 is a sequence diagram showing another example of access between the private network and the global network according to Embodiment 1;

FIG. 14 is a block diagram showing the configuration of a gateway apparatus according to Embodiment 2 of the present invention;

FIG. 15 illustrates an example of the SRV record according to Embodiment 2;

FIG. 16 illustrates an example of the address management table according to Embodiment 2;

FIG. 17 illustrates an example of the port management table according to Embodiment 2;

FIG. 18 illustrates an example of the address transfer table according to Embodiment 2;

FIG. 19 is a flow chart showing processing at the table setting section according to Embodiment 2;

FIG. 20 is a flow chart showing processing at the Twice-NAT processing section according to Embodiment 2;

FIG. 21 is a sequence diagram showing an example of access between the private network and the global network according to Embodiment 2;

FIG. 22 is a block diagram showing the configuration of a gateway apparatus according to Embodiment 3 of the present invention;

FIG. 23 is a sequence diagram showing a table setting operation according to Embodiment 3; and

FIG. 24 is a sequence diagram showing an example of access between the private network and the global network according to Embodiment 3.

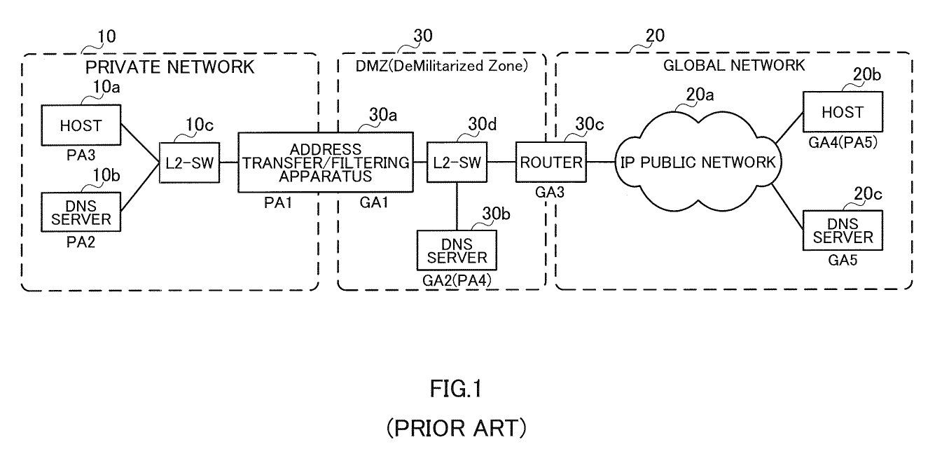

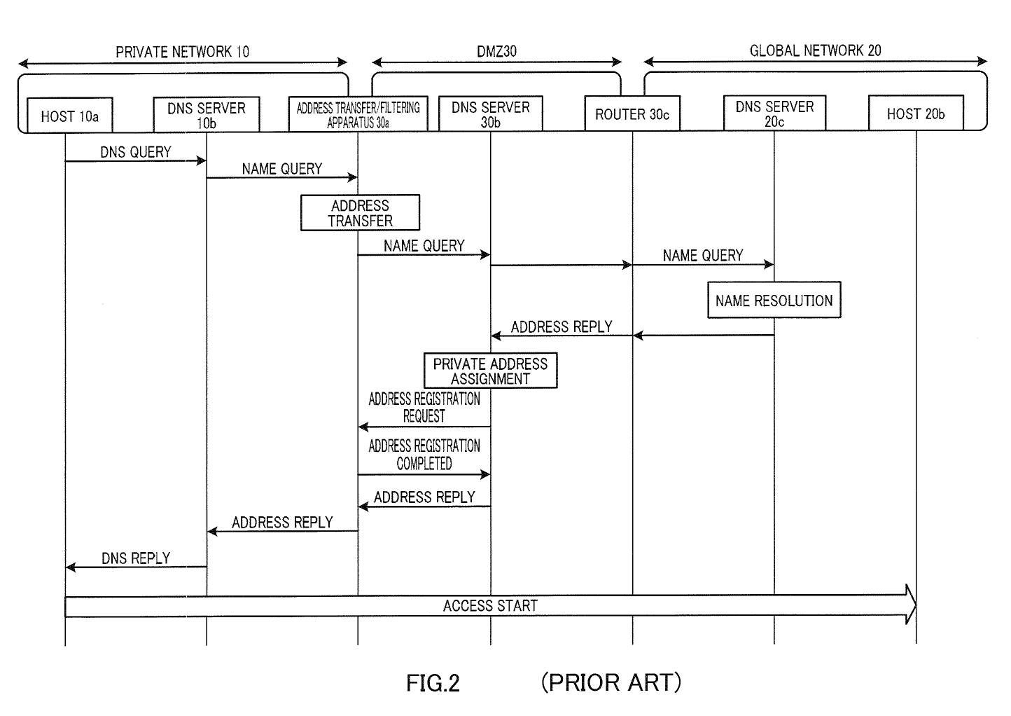

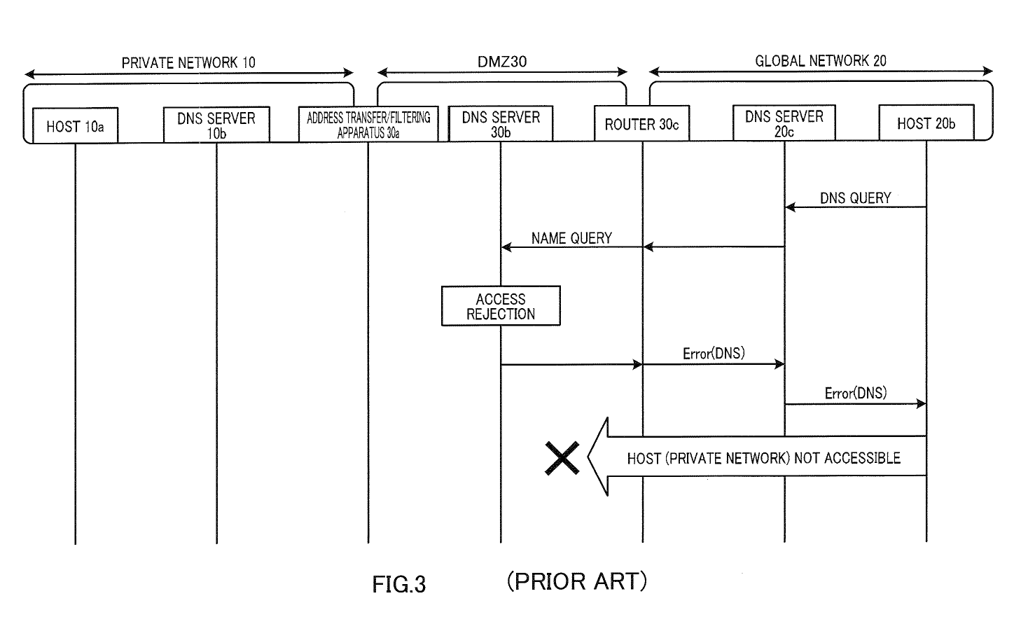

### BEST MODE FOR CARRYING OUT THE INVENTION

Now, embodiments of the present invention will be explained in detail with reference to the attached drawings.

### Embodiment 1

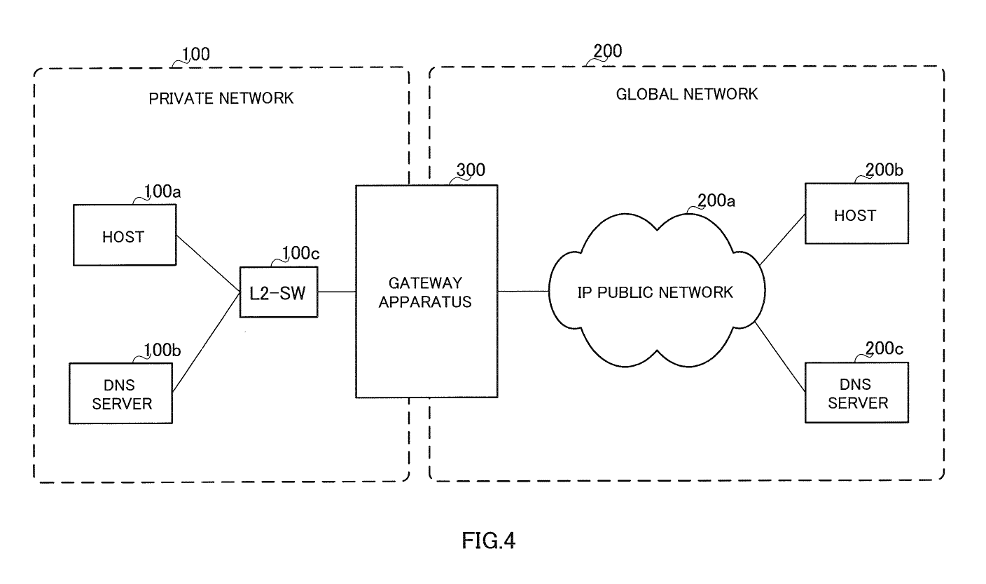

FIG. 4 illustrates an example of the network configuration according to Embodiment 1 of the present invention. The network shown in the same figure is provided with private network 100, global network 200 and gateway apparatus 300. Private network 100 includes host 100a having domain name “a.private.com” (private IP address “PA3”), DNS server 100b (private IP address “PA2”) that manages the domain name of the host in private network 100 and L2-SW 100c. On the other hand, global networks 200 includes IP public network 200a, host 200b having domain name “a.global.com” (global IP address “GA4”) and DNS server 200c that manages the domain name of the host (global IP address “GA3”) in the global network 200. Furthermore, gateway apparatus 300 is assigned private IP address “PA1” on the private network 100 side and assigned global IP address “GA1”, “GA2” and “GA5” on the global network 200 side. This gateway apparatus 300 is provided with a DNS proxy function and a Twice-NAT function.

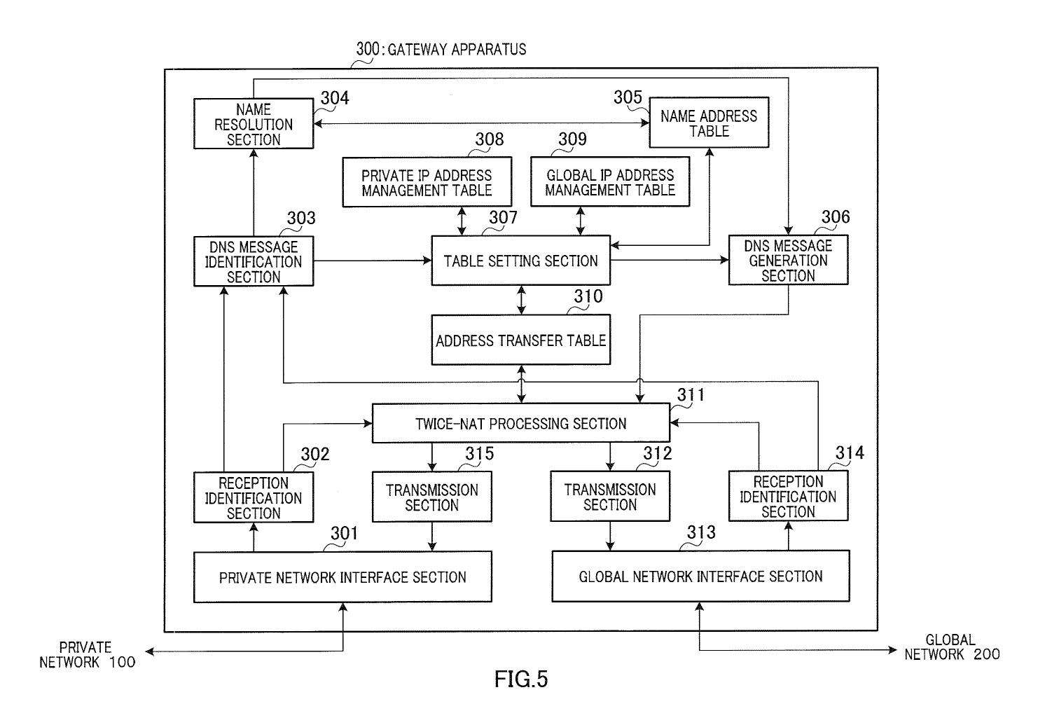

FIG. 5 is a block diagram showing the configuration of gateway apparatus 300 according to this embodiment. As shown in FIG. 5, gateway apparatus 300 is provided with private network interface section 301, reception identification section 302, DNS message identification section 303, name resolution section 304, name-address table 305, DNS message generation section 306, table setting section 307, private IP address management table 308, global IP address management table 309, address transfer table 310, Twice-NAT processing section 311, transmission section 312, global network interface section 313, reception identification section 314 and transmission section 315.

Private network interface section 301 is an interface with private network 100, outputs a signal received from private network 100 to reception identification section 302 and also transmits a signal output from transmission section 315 to private network 100.

Reception identification section 302 identifies whether or not the signal from private network 100 is a DNS message about a name resolution, transfers a DNS message to DNS message identification section 303 on one hand and transfers any message other than a DNS message to Twice-NAT processing section 311 on the other.

DNS message identification section 303 identifies whether the DNS message is a name query message including a domain name of a packet transfer destination (hereinafter, simply referred to as “name query”) or an address reply message including an IP address of the packet transfer destination (hereinafter, simply referred to as “address reply”), transfers the name query to name resolution section 304 on one hand and transfers the address reply to table setting section 307 on the other.

Name resolution section 304 extracts a domain name included in the name query, searches the domain name from name-address table 305 and acquires the address which corresponds to this domain name. When name resolution section 304 has acquired the IP address successfully, it transfers IP address information to DNS message generation section 306 and instructs it to transfer the IP address information to the sender of the name query as an address reply. On the other hand, when name resolution section 304 has failed to acquire the IP address, it instructs DNS message generation section 306 to transfer a name query to another DNS server capable of a name resolution.

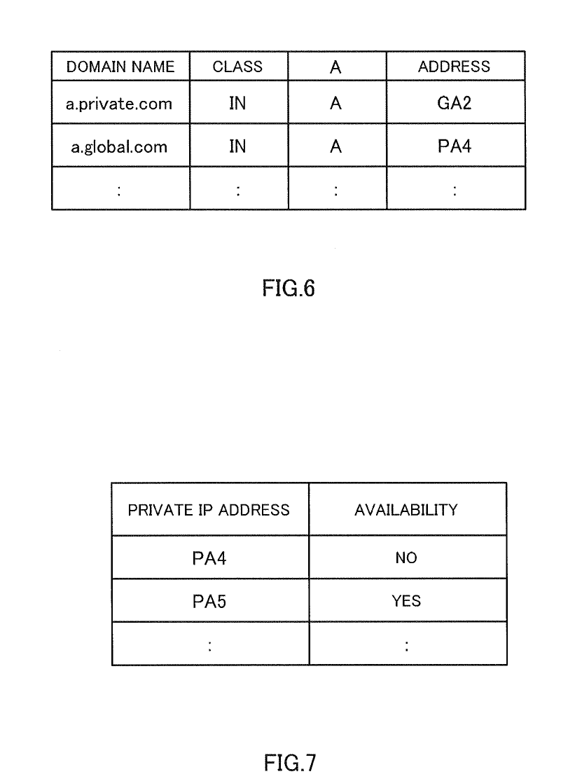

Name-address table 305 stores domain names in association with addresses as shown, for example, in FIG. 6 and name resolution section 304 refers to it in the case of a name resolution. Addresses stored in name-address table 305 are addresses registered in address transfer table 310 which will be described later, and the domain name (e.g., “a.global.com”) of the host (e.g., host 200b) of global network 200 is associated with a private IP address (e.g., “PA4”) and the domain name (e.g., “a.private.com”) of the host (e.g., host 100a) of private network 100 is associated with a global IP address (e.g., “GA2”).

DNS message generation section 306 generates a name query and a message of an address reply and transfers them to a specified transfer destination.

Table setting section 307 determines the correspondence between private IP addresses and global IP addresses and registers the correspondence in name-address table 305 and address transfer table 310. The processing by table setting section 307 will be explained in detail later.

As shown, for example, in FIG. 7, private IP address management table 308 is a list of private IP addresses which can be assigned to the host (e.g., host 200b) of global network 200. That is, private IP address management table 308 manages whether or not each private IP address is available (“No” when used for other mapping and “Yes” when not used for other mapping).

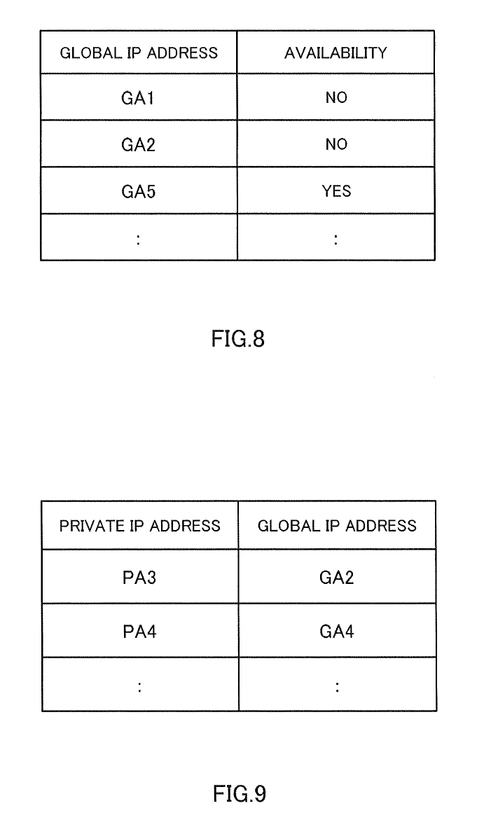

As shown, for example, in FIG. 8, global IP address management table 309 is a list of global IP addresses which can be assigned when performing address mapping. That is, global IP address management table 309 manages whether or not each global IP address is available (“No” when used for other mapping and “Yes” when not used for other mapping).

As shown, for example, in FIG. 9, address transfer table 310 stores private IP addresses in association with global IP addresses and is referred to when Twice-NAT processing section 311 performs Twice-NAT.

Twice-NAT processing section 311 converts both of the sender address and the destination address of a message other than DNS from private network 100 or global network 200 to global IP addresses or private IP addresses and outputs them to transmission section 312 or transmission section 315. The processing by Twice-NAT processing section 311 will be explained in detail later.

Transmission section 312 transmits a signal output from Twice-NAT processing section 311 to global network 200 through global network interface section 313.

Global network interface section 313 is an interface with global network 200, transmits the signal output from transmission section 312 to global network 200 and also outputs a signal received from global network 200 to reception identification section 314.

Reception identification section 314 identifies whether or not the signal from global network 200 is a DNS message about a name resolution and transfers the DNS message to DNS message identification section 303 on one hand and transfers any message other than the DNS message to Twice-NAT processing section 311 on the other.

Transmission section 315 transmits the signal output from Twice-NAT processing section 311 to private network 100 through private network interface section 301.

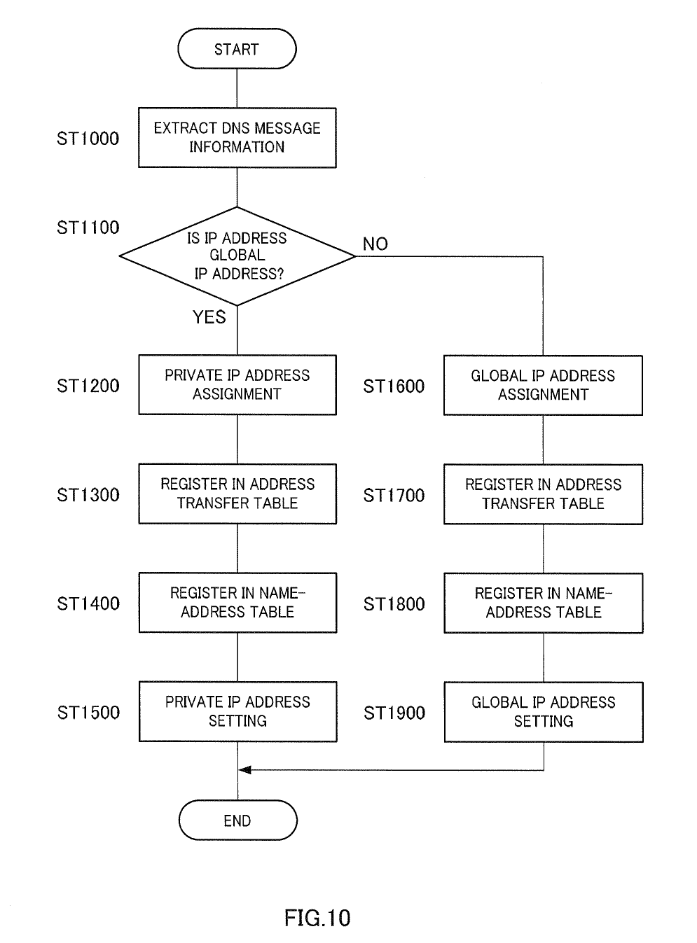

Next, the processing by table setting section 307 will be explained with reference to a flow chart shown in FIG. 10.

The DNS message of an address reply is input to table setting section 307 from DNS message identification section 303. Table setting section 307 extracts information from this address reply (ST1000) and decides whether or not the IP address included in the address reply is a global IP address (ST1100).

When the IP address is a global IP address, table setting section 307 selects an available private IP address from private IP address management table 308 and assigns the selected private IP address to the global IP address included in the address reply (ST1200). The global IP address and private IP address are associated with each other and registered in address transfer table 310 (ST1300). Furthermore, the domain name which corresponds to the global IP address and the selected private IP address are registered in name-address table 305 (ST1400). Table setting section 307 then instructs DNS message generation section 306 to transfer the private IP address selected in ST1200 as an address reply to DNS server 100b in private network 100 (ST1500).

On the other hand, when the decision result in ST1100 shows that the IP address is not a global IP address, table setting section 307 selects an available global IP address from global IP address management table 309 and assigns the selected global IP address to the private IP address included in the address reply (ST1600). The private IP address and global IP address are associated with each other and registered in address transfer table 310 (ST1700). Furthermore, the domain name which corresponds to the private IP address and the selected global IP address are registered in name-address table 305 (ST1800). Table setting section 307 then instructs DNS message generation section 306 to transfer the global IP address selected in ST1600 to DNS server 200c in global network 200 as the address reply (ST1900).

Address transfer table 310 and name-address table 305 are set in this way, and gateway apparatus 300 assigns a global IP address to the host (e.g., host 100a) in private network 100 and assigns a private IP address to the host (e.g., host 200b) in global network 200.

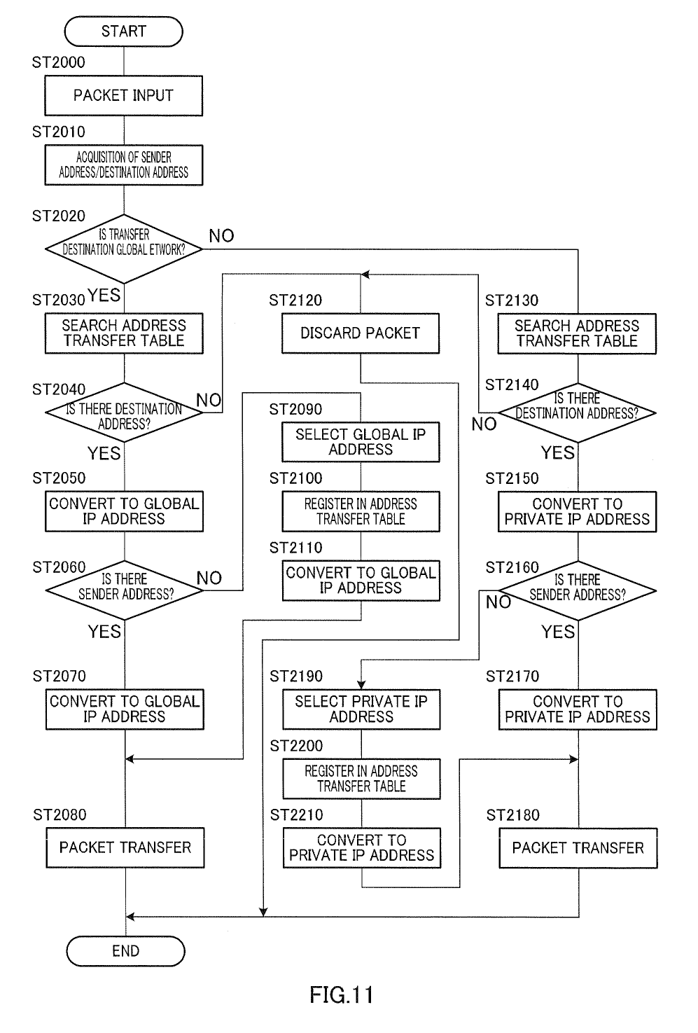

Next, the processing by Twice-NAT processing section 311 will be explained with reference to a flow chart shown in FIG. 11.

A message of an IP packet or the like other than a DNS message is input to Twice-NAT processing section 311 from reception identification section 302 or reception identification section 314 (ST2000). Twice-NAT processing section 311 then acquires the sender address and the destination address of the IP packet (ST2010) and decides whether the transfer destination of the IP packet is global network 200 or private network 100 (ST2020).

When the transfer destination is global network 200, Twice-NAT processing section 311 searches the destination address from address transfer table 310 (ST2030) and decides the presence/absence of the destination address (ST2040). As a result, when the destination address is not registered in address transfer table 310, the packet is discarded (ST2120). Furthermore, when the destination address is registered in address transfer table 310, address transfer table 310 is referred to and the destination address is converted to a corresponding global IP address (ST2050).

The sender address is then searched from address transfer table 310 and the presence/absence of the sender address is decided (ST2060). When the result shows that the sender address is registered in address transfer table 310, the sender address is converted to a corresponding global IP address (ST2070) and an IP packet is transferred to transmission section 312 (ST2080). On the other hand, when the sender address is not registered in address transfer table 310, such information is reported to table setting section 307, an available global IP address is selected from global IP address management table 309 (ST2090), the sender address of the IP packet and the selected global IP address are associated with each other and registered in address transfer table 310 (ST2100). Furthermore, the sender address is converted to the selected global IP address by Twice-NAT processing section 311 (ST2110) and the IP packet is transferred to transmission section 312 (ST2080).

On the other hand, when the decision result in ST2020 shows that the destination is private network 100, Twice-NAT processing section 311 searches the destination address from address transfer table 310 (ST2130) and decides the presence/absence of the destination address (ST2140). When this result shows that the destination address is not registered in address transfer table 310, the packet is discarded (ST2120). On the other hand, when the destination address is registered in address transfer table 310, address transfer table 310 is referred to and the destination address is converted to a corresponding private IP address (ST2150).

After that, the sender address is searched from address transfer table 310 and the presence/absence of the sender address is decided (ST2160). When this result shows that the sender address is registered in address transfer table 310, the sender address is converted to a corresponding private IP address (ST2170) and an IP packet is transferred to transmission section 315 (ST2180). Furthermore, when the sender address is not registered in address transfer table 310, such information is reported to table setting section 307 and an available private IP address is selected from private IP address management table 308 (ST2190), the sender address of the IP packet and the selected private IP address are associated with each other and registered in address transfer table 310 (ST2200). Moreover, Twice-NAT processing section 311 converts the sender address to the selected private IP address (ST2210) and an IP packet is transferred to transmission section 315 (ST2180).

In this way, gateway apparatus 300 converts both the destination address and the sender address to IP addresses in the network of the packet transfer destination, and therefore in the case of access across two networks, it is possible to conceal the actual IP address of the packet transfer destination from the host of the packet sender and improve security.

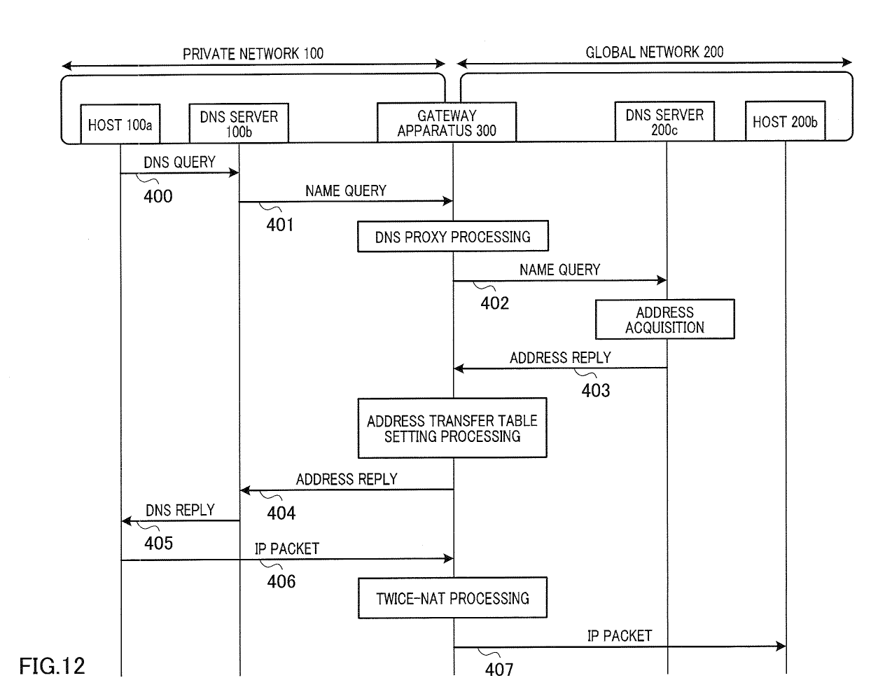

Next, access between private network 100 and global network 200 will be explained. First, access from private network 100 to global network 200 will be explained with reference to the sequence diagram shown in FIG. 12.

First, host 100a in private network 100 transmits a name resolution request (DNS query) 400 of domain name “a.global.com” to DNS server 100b in private network 100. However, since domain name “a.global.com” is not registered in DNS server 100b, name query 401 is transmitted to gateway apparatus 300.

Name query 401 is input to name resolution section 304 via private network interface section 301, reception identification section 302 and DNS message identification section 303 of gateway apparatus 300, and name resolution section 304 tries a name resolution. That is, domain name “a.global.com” is searched from name-address table 305. Here, if access was made from private network 100 to host 200b of domain name “a.global.com” in the past, since the private IP address which corresponds to domain name “a.global.com” is registered in name-address table 305, this private IP address is sent back to host 100a.

The explanation will be continued below assuming that no access was made to host 200b in the past and domain name “a.global.com” is not registered in name-address table 305. In this case, a name query is generated by DNS message generation section 306 and name query 402 is transferred to DNS server 200c in global network 200. DNS server 200c searches “a.global.com” from the name-address table stored in DNS server 200c and acquires global IP address “GA4.” After acquiring the global IP address, DNS server 200c transfers address reply 403 including global IP address “GA4” to gateway apparatus 300.

Gateway apparatus 300 which has received address reply 403 performs processing through above described table setting section 307. That is, available private IP address “PA4” is selected from private IP address management table 308, associated with actual global IP address “GA4” and registered in address transfer table 310. Furthermore, domain name “a.global.com” and private IP address “PA4” are registered in name-address table 305.

After the processing through table setting section 307 ends, DNS message generation section 306 generates an address reply including private IP address “PA4” and address reply 404 is transmitted from transmission section 315 to DNS server 100b through private network interface section 301. DNS server 100b transfers DNS reply 405 indicating that the IP address of domain name “a. global. com” is private IP address “PA4” to host 100a. Therefore, actual global IP address “GA4” of host 200b in global network 200 is concealed from host 100a and DNS server 100b in private network 100. Host 100a then sends IP packet 406 to gateway apparatus 300 by designating private IP address “PA3” as the sender address and private IP address “PA4” as the destination address.

Gateway apparatus 300 which has received IP packet 406 performs processing through above described Twice-NAT processing section 311. That is, Twice-NAT processing section 311 refers to address transfer table 310 and converts private IP address “PA4” of the destination address to global IP address “GA4”. Furthermore, Twice-NAT processing section 311 generates address mapping for the sender address and converts sender address “PA3” to global IP address “GA1” which corresponds to the mapping. In this way, after Twice-NAT whereby both the destination address and the sender address are converted to global IP addresses is performed, IP packet 407 is transmitted to host 200b in global network 200. Therefore, actual private IP address “PA3” of host 100a in private network 100 is concealed from host 200b in global network 200.

After that, in a communication from host 100a in private network 100 to host 200b in global network 200, gateway apparatus 300 performs Twice-NAT based on address transfer table 310.

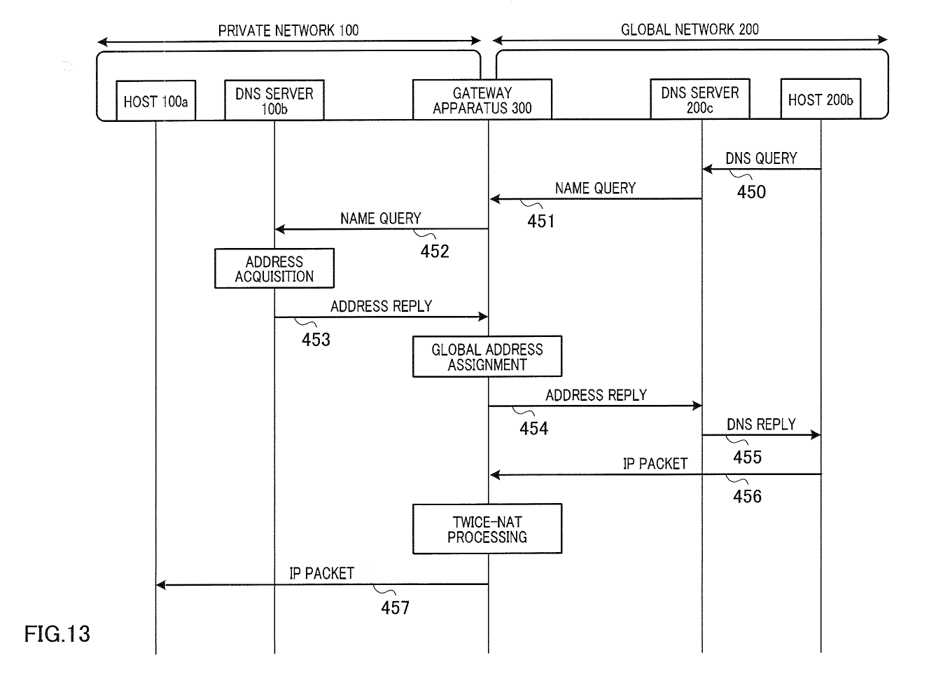

Next, access in a direction opposite to the above described access, that is, access from global network 200 to private network 100 will be explained with reference to the sequence diagram shown in FIG. 13.

First, host 200b in global network 200 transmits DNS query 450 about domain name “a.private.com” to DNS server 200c in global network 200. However, since domain name “a.private.com” is not registered in DNS server 200c, name query 451 is transmitted to gateway apparatus 300.

Name query 451 is input to name resolution section 304 via global network interface section 313, reception identification section 314 and DNS message identification section 303 and name resolution section 304 tries a name resolution. Here, the explanation will be continued assuming that as in the case of the above described access from private network 100 to global network 200, domain name “a.private.com” is not registered in name-address table 305. In this case, name query 452 generated by DNS message generation section 306 is transferred to DNS server 100b in private network 100. DNS server 100b searches “a.private.com” from the name-address table stored in DNS server 100b and acquires private IP address “PA3”. After acquiring the private IP address, DNS server 100b transfers address reply 453 including private IP address “PA3” to gateway apparatus 300.

Gateway apparatus 300 which has received address reply 453 performs processing through above described table setting section 307. That is, available global IP address “GA2” is selected from global IP address management table 309, associated with actual private IP address “PA3” and registered in address transfer table 310. Furthermore, domain name “a.private.com” and global IP address “GA2” are registered in name-address table 305.

After the processing through table setting section 307 ends, DNS message generation section 306 generates an address reply including global IP address “GA2” and address reply 454 is transmitted from transmission section 312 to DNS server 200c through global network interface section 313. DNS server 200c transfers DNS reply 455 indicating that the IP address of domain name “a.private.com” is global IP address “GA2” to host 200b. Therefore, actual private IP address “PA3” of host 100a in private network 100 is concealed from host 200b and DNS server 200c in global network 200. Host 200b then transmits IP packet 456 to gateway apparatus 300 by designating global IP address “GA4” as the sender address and global IP address “GA2” as the destination address.

The gateway apparatus 300 which has received IP packet 456 performs the above described processing through Twice-NAT processing section 311. That is, Twice-NAT processing section 311 refers to address transfer table 310 and converts global IP address “GA2” of the destination address to private IP address “PA3”. Furthermore, Twice-NAT processing section 311 selects available private IP address “PA4” from private IP address management table 308 as the private IP address which corresponds to the sender address, registers global IP address “GA4” which is the sender address and selected private IP address “PA4” in address transfer table 310 and converts the sender address to private IP address “PA4”. In this way, after the Twice-NAT whereby both the destination address and the sender address are converted to private IP addresses is performed, IP packet 457 is transmitted to host 100a in private network 100. Therefore, actual global IP address “GA4” of host 200b in the global network is concealed from host 100a in private network 100.

After that, gateway apparatus 300 performs Twice-NAT based on address transfer table 310 in the communication from host 200b in global network 200 to host 100a in private network 100.

As shown above, according to this embodiment, when a communication between the global network and the private network is performed, the gateway apparatus converts the IP address which corresponds to the domain name at the time of a name resolution to an unused IP address in the sender network and also converts the sender address and the destination address to IP addresses in the network of the packet transfer destination when the IP packet is transmitted. Therefore, without IP addresses being actually exchanged beyond the mutual networks, it is possible to allow access from the global network side to the private network side while maintaining security and realize intercommunication between the global network and the private network.

### Embodiment 2

A feature of Embodiment 2 of the present invention is to maintain an SRV (SeRVice) record capable of reporting not only a name-address table but also a port number, report a global IP address and a port as an address reply to a name query from the host of the global network and thereby use NAPT (Network Address Port Transfer) instead of NAT at the time of a conversion of the destination address.

Since the network configuration according to this embodiment is the same as that in FIG. 4 (Embodiment 1), explanations thereof will be omitted. However, unlike Embodiment 1, gateway apparatus 300 on the global network 200 side of this embodiment is assigned only global IP address “GA1”.

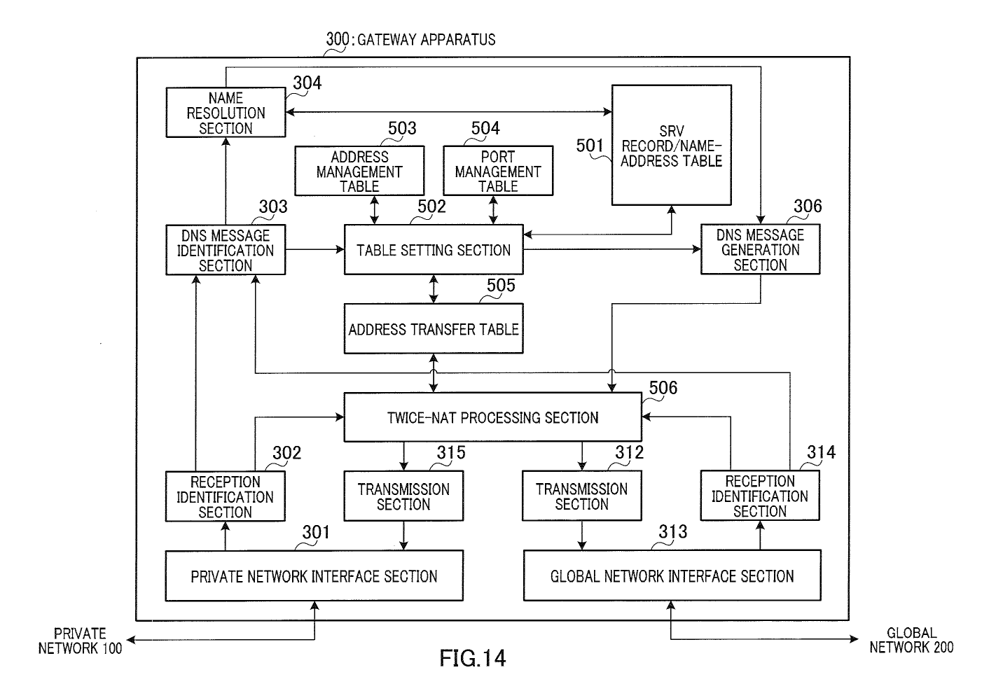

FIG. 14 is a block diagram showing the configuration of gateway apparatus 300 according to this embodiment. In the same figure, the same parts as those in FIG. 5 are assigned the same reference numerals and explanations thereof will be omitted. As shown in FIG. 14, gateway apparatus 300 is provided with private network interface section 301, reception identification section 302, DNS message identification section 303, name resolution section 304, SRV record/name-address table 501, DNS message generation section 306, table setting section 502, address management table 503, port management table 504, address transfer table 505, Twice-NAT processing section 506, transmission section 312, global network interface section 313, reception identification section 314 and transmission section 315.

SRV record/name-address table 501 stores, for example, SRV records shown in FIG. 15 in addition to the information of name-address table 305 in Embodiment 1. Here, the SRV record is defined in RFC (Request For Comment) 2782 published by IETF (Internet Engineering Task Force) and refers to information necessary for the Internet other than the domain name and the IP address intended to provide a load distribution service, securing of redundancy and report of service port numbers. According to the SRV record, a name resolution is performed under “_Service._Proto.Name”. “_Service” in “_Service._Proto.Name” denotes a service name, and one defined in RFC1700 (e.g., www in the case of a Web service) or one independently defined can be used. Furthermore, “_Proto” denotes a protocol name and “Name” denotes a domain name. For example, in the case of “private.com” which has a Web service, “_Service._Proto.Name” becomes “_www._tcp.private.com.” Furthermore, it is possible to assign priority to each entry registered in the SRV record according to “priority” in the SRV record. Furthermore, “port” denotes a service port number and “target” denotes the name of the host which provides the service. Suppose all port numbers registered in gateway apparatus 300 in this embodiment are global ports.

Table setting section 502 determines the correspondence between private IP addresses and global IP addresses and registers the correspondence in SRV record/name-address table 501 and address transfer table 505, determines the correspondence between global ports and private ports and registers the correspondence in SRV record/name-address table 501 and address transfer table 505. The processing of table setting section 502 will be explained in detail later.

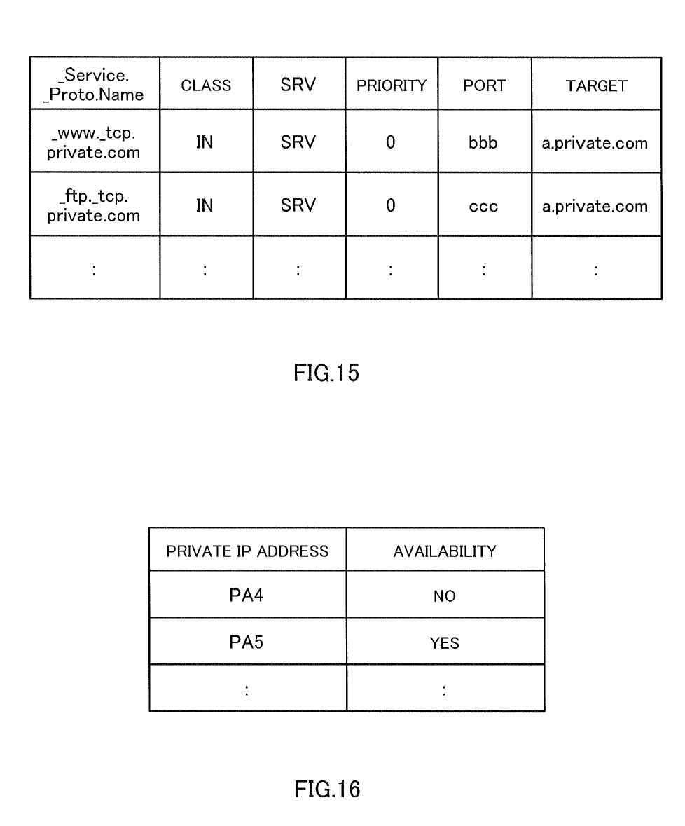

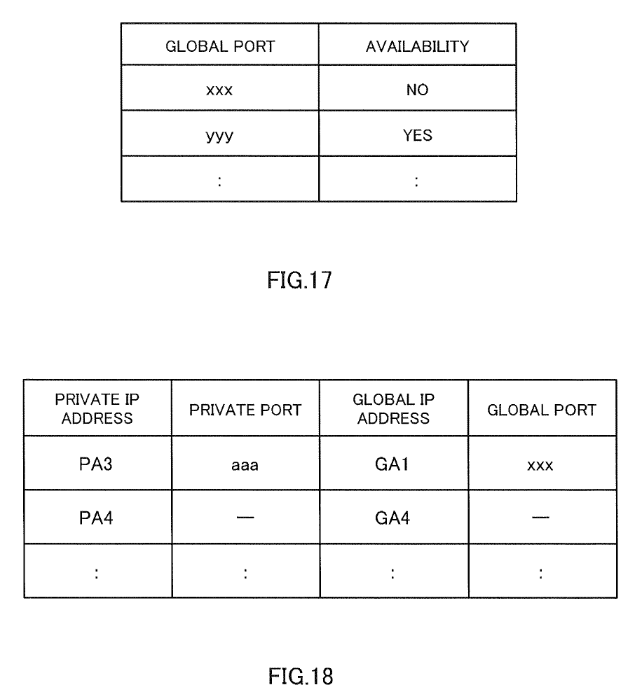

As shown, for example, in FIG. 16, address management table 503 is a list of private IP addresses which can be assigned to the host of global network 200 (e.g., host 200b). That is, private IP address management table 308 manages whether or not each private IP address is available (“No” when used for other mapping and “Yes” when not used).

As shown, for example, in FIG. 17, port management table 504 is a list of global ports which can be assigned to the host of private network 100 (e.g., host 100a). That is, port management table 504 manages whether or not each global port is available (“No” when used for other mapping and “Yes” when not used).

As shown in, for example, FIG. 18, address transfer table 505 stores private IP addresses, private ports, global IP addresses and global ports associated with each other and Twice-NAT processing section 506 refers to it in the case of Twice-NAT. When a private port and a global port are not registered in address transfer table 505, conversion of ports by Twice-NAT processing section 506 is not performed.

Twice-NAT processing section 506 converts both the sender address and the destination address of a message other than DNS from private network 100 or global network 200 to a global IP address or a private IP address and also converts the global port and the private port and outputs them to transmission section 312 or transmission section 315. The processing of Twice-NAT processing section 506 will be explained in detail later.

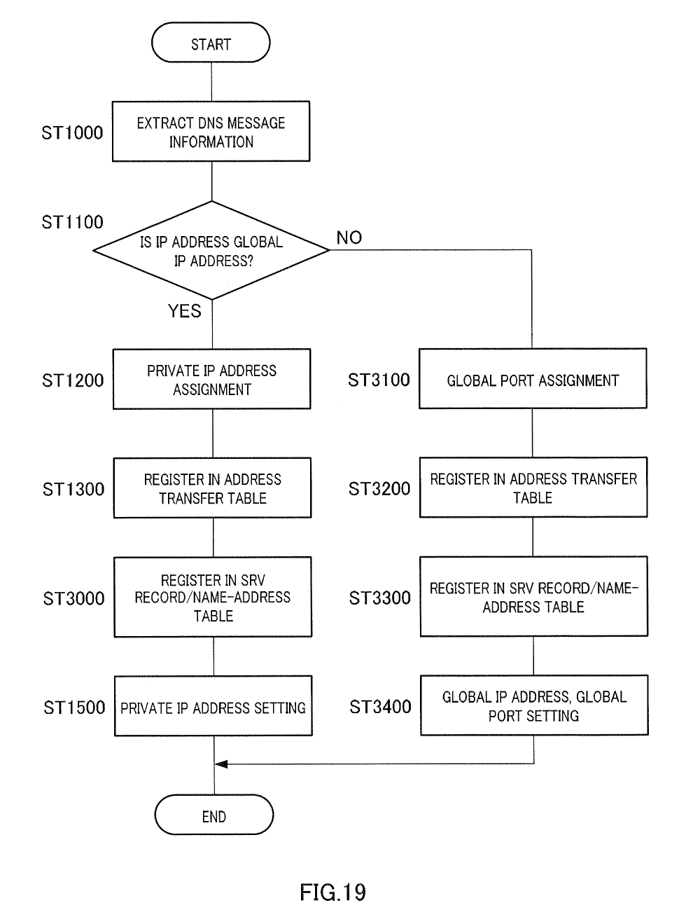

Next, the processing of table setting section 502 will be explained with reference to the flow chart shown in FIG. 19. In the same figure, the same parts as those in FIG. 10 (Embodiment 1) are assigned the same reference numerals and detailed explanations thereof will be omitted.

First, as in the case of Embodiment 1, it is decided whether or not an IP address which is included in an address reply input to table setting section 502 is a global IP address (ST1100). When the IP address is a global IP address, an available private IP address selected from address management table 503 is assigned to this global IP address (ST1200), the global IP address and private IP address are associated with each other and registered in address transfer table 505 (ST1300). Furthermore, the domain name which corresponds to the global IP address and the selected private IP address are registered in SRV record/name-address table 501 (ST3000). After that, table setting section 502 sends an instruction to DNS message generation section 306 to transfer an address reply including the selected private IP address to DNS server 100b (ST1500).

On the other hand, when the decision result in ST1100 shows that the IP address is not a global IP address, table setting section 502 selects an available global port from port management table 504 and assigns the selected global port to the private IP address and the private port included in the address reply (hereinafter, expressed as “private IP address/port”) (ST3100). The private IP address/port, the global IP address of gateway apparatus 300 and the selected global port are associated with each other and registered in address transfer table 505 (ST3200). Furthermore, the domain name which corresponds to the private IP address, the global IP address of gateway apparatus 300 and the selected global port are registered in SRV record/name-address table 501 as an SRV record (ST3300). After that, table setting section 502 sends an instruction to DNS message generation section 306 to transfer the global IP address of gateway apparatus 300 and the global port selected in ST3100 to DNS server 200c in global network 200 as an address reply (ST3400).

Address transfer table 505 and SRV record/name-address table 501 are set in this way, and gateway apparatus 300 thereby assigns the global IP address and global port of gateway apparatus 300 to the host (e.g., host 100a) in private network 100 and assigns the private IP address to the host (e.g., host 200b) in global network 200.

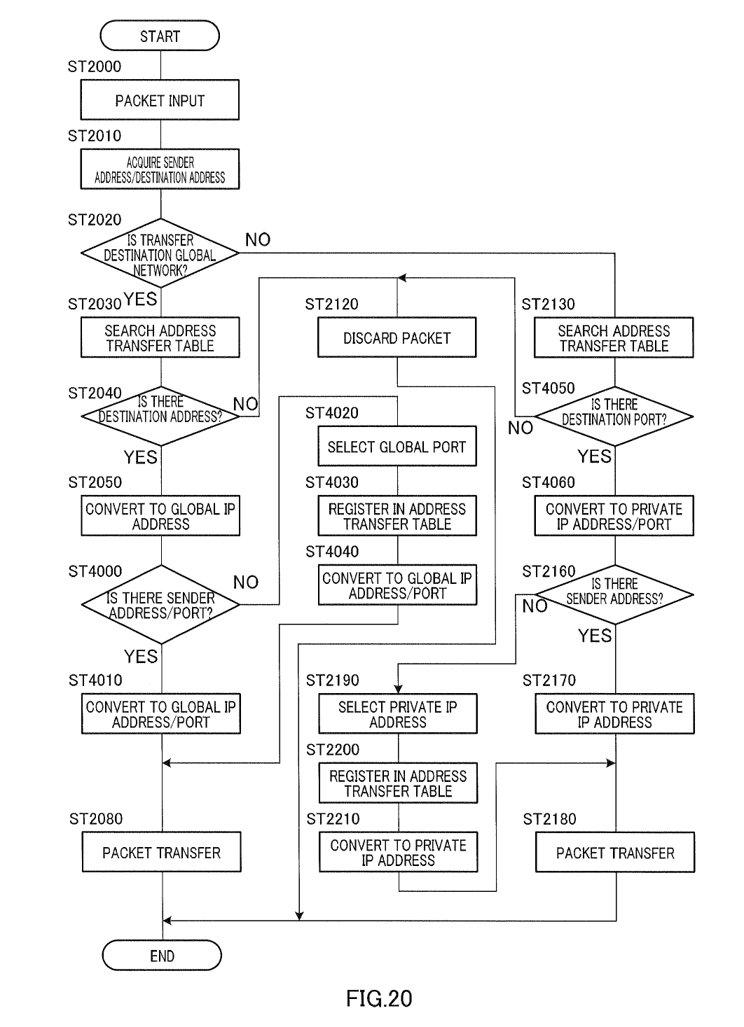

Next, the processing of Twice-NAT processing section 506 will be explained with reference to the flow chart shown in FIG. 20. In the same figure, the same parts as those in FIG. 11 (Embodiment 1) are assigned the same reference numerals and detailed explanations thereof will be omitted.

A message of an IP packet other than a DNS message of the like is input to Twice-NAT processing section 506 from reception identification section 302 or reception identification section 314 (ST2000). As in the case of Embodiment 1, Twice-NAT processing section 506 acquires the sender address, the sender port and the destination address of the IP packet (ST2010), decides the transfer destination of the IP packet (ST2020), and when the transfer destination of the IP packet is global network 200, Twice-NAT processing section 506 decides the presence/absence of the destination address in address transfer table 505 (ST2040). When the decision result shows that the destination address is not registered in address transfer table 505, the packet is discarded (ST2120), whereas when the destination address is registered in address transfer table 505, the destination address is converted to a corresponding global IP address (ST2050).

After that, a sender address and a sender port are searched from address transfer table 505 and the presence/absence of the sender address and the sender port are decided (ST4000). As a result, when the sender address and the sender port are registered in address transfer table 505, the sender address and sender port are converted to a global IP address and a global port (ST4010) and an IP packet is transferred to transmission section 312 (ST2080). Furthermore, when the sender address and the sender port are not registered in address transfer table 505, such information is reported to table setting section 502, an available global port is selected from port management table 504 (ST4020), the sender port of the IP packet and the selected global port are associated with each other and registered in address transfer table 505(ST4030). Furthermore, Twice-NAT processing section 506 converts the sender address and the sender port to the global IP address of gateway apparatus 300 and the selected global port respectively (ST4040) and an IP packet is transferred to transmission section 312 (ST2080).

On the other hand, when the decision result in ST2020 shows that the transfer destination is private network 100, Twice-NAT processing section 506 searches the destination address from address transfer table 505 (ST2130) and decides the presence/absence of the destination port (ST4050). As a result, when the destination port is not registered in address transfer table 505, the packet is discarded (ST2120). Furthermore, when the destination port is registered in address transfer table 505, address transfer table 505 is referred to and the destination address and the destination port are converted to a corresponding private IP address and private port respectively (ST4060).

After that, as in the case of Embodiment 1, the sender address is searched from address transfer table 505, and when the sender address is registered in address transfer table 505, the sender address is converted to a corresponding private IP address (ST2170) and an IP packet is transferred to transmission section 315 (ST2180). Furthermore, when the sender address is not registered in address transfer table 505, an available private IP address is assigned to the sender address, registered and the sender address is converted to this private IP address (ST2210) and an IP packet is transferred to transmission section 315 (ST2180).

In this way, gateway apparatus 300 converts both of the destination address and the sender address and the destination port or the sender port to the IP address and the port in the network of the packet transfer destination, and therefore in access across two networks, it is possible to conceal the actual IP address of the packet transfer destination from the host of the packet sender and improve security.

Next, access between private network 100 and global network 200 will be explained. Access from private network 100 to global network 200 according to this embodiment is the same as that in Embodiment 1 except in that not only the sender address but also the sender port is converted to the global port, and therefore explanations thereof will be omitted.

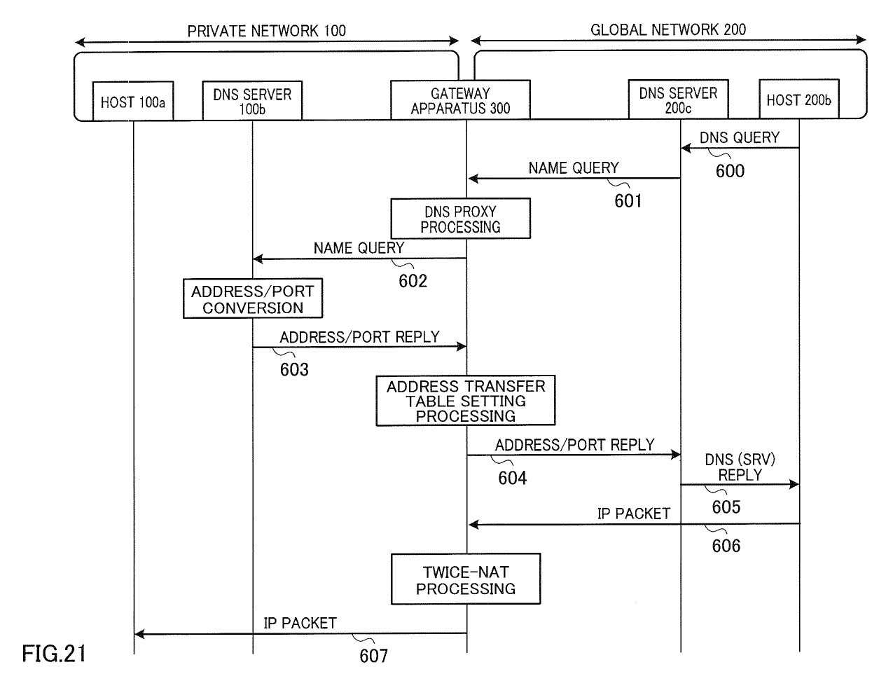

Therefore, access from global network 200 to private network 100 will be explained with reference to the sequence diagram shown in FIG. 21.

First, host 200b in global network 200 transmits DNS query 600 about _Service._Proto.Name “_www._tcp.private.com” to DNS server 200c in global network 200. However, since _Service._Proto.Name “_www._tcp.private.com” is not registered in DNS server 200c, name query 601 is transmitted to gateway apparatus 300.

Name query 601 is input to name resolution section 304 via global network interface section 313, reception identification section 314 and DNS message identification section 303 and name resolution section 304 tries a name resolution. Here, the explanation will be continued assuming that _Service._Proto.Name “_www._tcp.private.com” is not registered in SRV record/name-address table 501. In this case, name query 602 generated by DNS message generation section 306 is transferred to DNS server 100b in private network 100. DNS server 100b searches “_www._tcp.private.com” from the name-address table stored in DNS server 100b, acquires private IP address “PA3” and private port “aaa”. After acquiring the private IP address/port, DNS server 100b transfers address/port reply 603 including private IP address “PA3” and private port “aaa” to gateway apparatus 300.

Gateway apparatus 300 which has received address/port reply 603 performs the above described processing through table setting section 502. That is, available global port “xxx” is selected from port management table 504, associated with global IP address “GA1” of gateway apparatus 300, actual private IP address “PA3” and private port “aaa” and registered in address transfer table 505. Furthermore, _Service._Proto.Name “_www._tcp.private.com”, global IP address “GA1” and global port “xxx” are associated with each other and registered in SRV record/name-address table 501.

After the processing through table setting section 502 ends, DNS message generation section 306 generates an address reply including global IP address “GA1” and global port “xxx”, address/port reply 604 is transmitted from transmission section 312 to DNS server 200c through global network interface section 313. DNS server 200c transfers DNS reply 605 indicating that the IP address of _Service._Proto.Name “_www._tcp.private.com” is global IP address “GA1” and the global port is “xxx” to host 200b. Therefore, actual private IP address “PA3” and private port “aaa” of host 100a in private network 100 are concealed from host 200b in global network 200 and DNS server 200c. Host 200b transmits IP packet 606 to gateway apparatus 300 by designating global IP address “GA4” as the sender address, global IP address “GA1” as the destination address and global port “xxx” as the destination port.

Gateway apparatus 300 which has received IP packet 606 performs the above described processing through Twice-NAT processing section 506. That is, Twice-NAT processing section 506 refers to address transfer table 505, converts global IP address “GA1” of the destination address and global port “xxx” of the destination port to private IP address “PA3” and private port “aaa” respectively. Furthermore, Twice-NAT processing section 506 selects available private IP address “PA4” from address management table 503 as the private IP address which corresponds to the sender address, registers global IP address “GA4” which is the sender address and selected private IP address “PA4” in address transfer table 505 and converts the sender address to private IP address “PA4”. After the Twice-NAT is performed whereby both of the destination address and the sender address are converted to the private IP addresses in this way, IP packet 607 is transmitted to host 100a in private network 100. Therefore, actual global IP address “GA4” of host 200b in the global network is concealed from host 100a in private network 100.

In subsequent communications from host 200b in global network 200 to host 100a in private network 100, gateway apparatus 300 performs Twice-NAT based on address transfer table 505.

As described above, according to this embodiment, when a communication between the global network and the private network is carried out, the gateway apparatus converts the IP address which corresponds to the domain name to an unused IP address in the sender network at the time of a name resolution and also converts the sender address and the destination address to IP addresses in the network of the packet transfer destination at the time of transmission of an IP packet. Therefore, without exchanging actual IP addresses beyond the mutual networks, it is possible to allow access from the global network side to the private network side while maintaining security and realize intercommunication between the global network and the private network.

Furthermore, this embodiment assigns only one global IP address to the gateway apparatus, identifies the global IP address with the port included in the SRV record, and can thereby prevent the gateway apparatus from occupying many IP addresses.

### Embodiment 3

A feature of Embodiment 3 of the present invention is that when a host in a private network is provided with a function of Plug & Play such as a UPnP (Universal Plug and Play) protocol, the gateway apparatus automatically creates port mapping.

Since the network configuration according to this embodiment is the same as that in FIG. 4 (Embodiment 1), explanations thereof will be omitted. However, unlike Embodiment 1, host 100a of this embodiment is provided with a UPnP protocol. Furthermore, gateway apparatus 300 of this embodiment is assigned only global IP address “GA1” on the global network 200 side as in the case of Embodiment 2.

“UPnP” is a technical specification standardized by a group called “UPnP Forum” to connect devices such as a personal computer, peripheral devices of the personal computer, audio visual equipment and home appliances in a household together through a network and mutually provide functions for each other. UPnP is based on standard techniques on the Internet and is under study with the aim of functioning by only connecting with the network without complicated operations and setting work. Furthermore, UPnP mainly has functions such as device detection, port mapping requesting from devices in a LAN and reporting of global IP addresses.

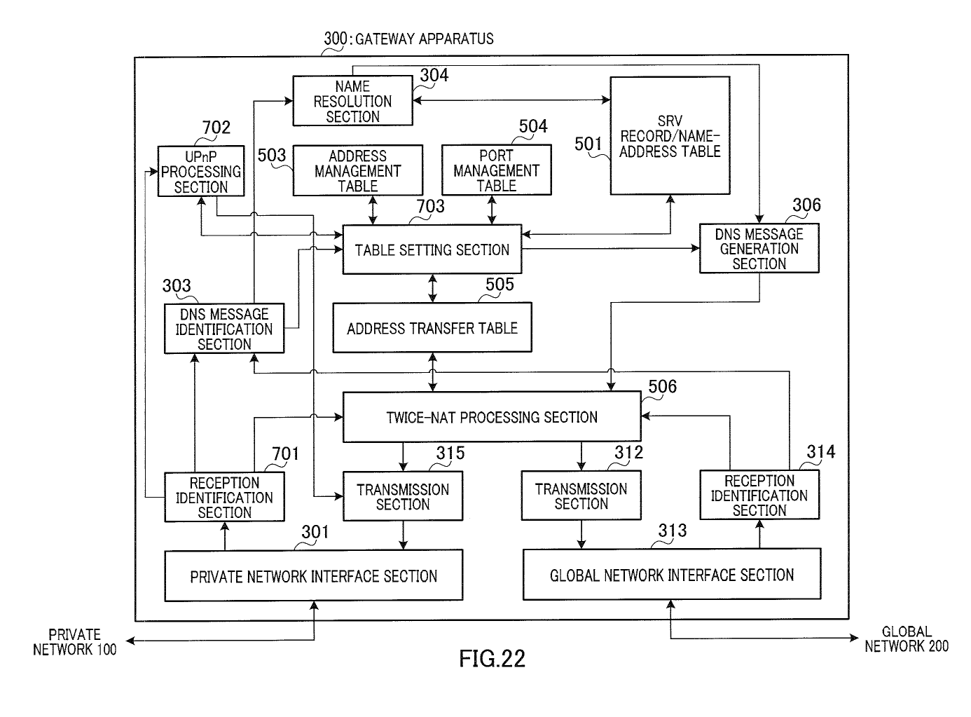

FIG. 22 is a block diagram showing the configuration of gateway apparatus 300 according to this embodiment. In the same figure, the same parts as those in FIG. 5 and FIG. 14 are assigned the same reference numerals and explanations thereof will be omitted. As shown in FIG. 22, gateway apparatus 300 is provided with private network interface section 301, reception identification section 701, DNS message identification section 303, name resolution section 304, SRV record/name-address table 501, DNS message generation section 306, table setting section 703, address management table 503, port management table 504, address transfer table 505, Twice-NAT processing section 506, transmission section 312, global network interface section 313, reception identification section 314, transmission section 315 and UPnP processing section 702.

Reception identification section 701 identifies whether a signal from private network 100 is a DNS message, UPnP message or other message, transfers a DNS message to DNS message identification section 303, transfers a UPnP message to UPnP processing section 702 and transfers other messages to Twice-NAT processing section 506.

When the UPnP message is a port mapping request, UPnP processing section 702 transmits a port mapping request including the private IP address of host 100a to table setting section 703. Furthermore, UPnP processing section 702 receives a port mapping request response from table setting section 703 and transfers the UPnP message indicating the reported global port to transmission section 315.

Upon receiving a port mapping request from UPnP processing section 702, table setting section 703 selects an available global port from port management table 504 and registers the private IP address/port included in the port mapping request, the global IP address of gateway apparatus 300 and the selected global port in address transfer table 505. Furthermore, table setting section 703 registers the global IP address of gateway apparatus 300 and the selected global port in SRV record/name-address table 501.

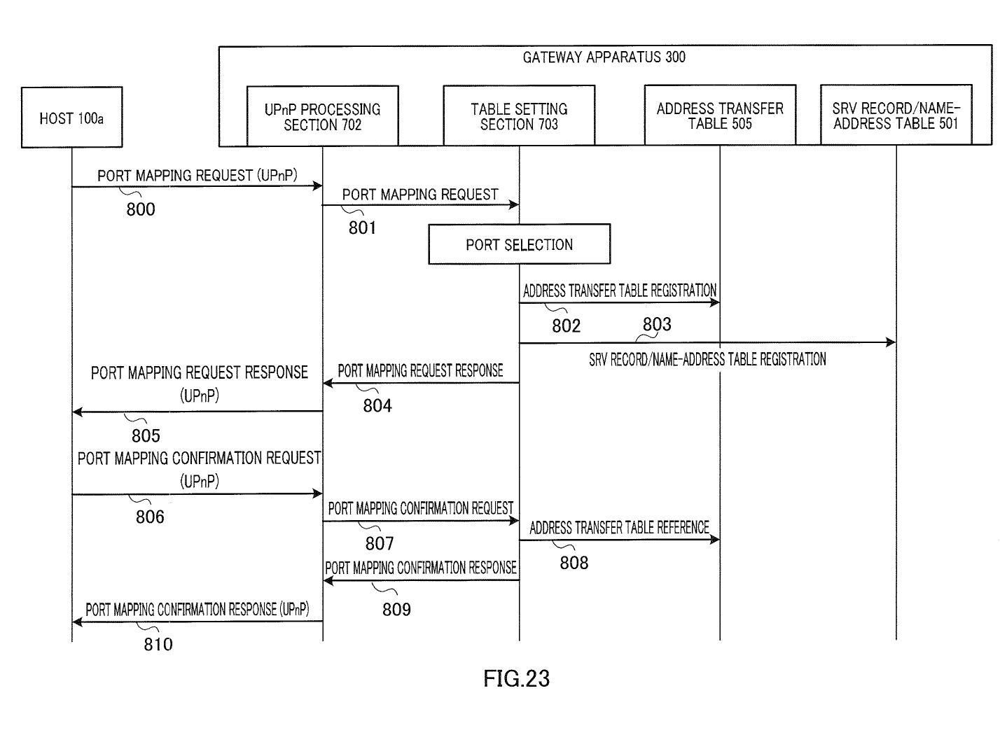

Next, the setting operations of address transfer table 505 and SRV record/name-address table 501 in gateway apparatus 300 configured as shown above will be explained with reference to the sequence diagram shown in FIG. 23.

First, when host 100a is started, gateway apparatus 300 is detected (device detection) according to UPnP of host 100a and port mapping request 800 is transmitted. Gateway apparatus 300 decides that the UPnP message received at UPnP processing section 702 is a port mapping request and transfers port mapping request 801 to table setting section 703. At this time, port mapping request 801 includes private IP address “PA3” and private port “aaa” of host 100a.

Table setting section 703 selects available global port “xxx” from port management table 504 and outputs address transfer table registration 802 to address transfer table 505. That is, table setting section 703 registers private IP address “PA3”, private port “aaa”, global IP address “GA1” of gateway apparatus 300 and selected port “xxx” in address transfer table 505.

Furthermore, table setting section 703 outputs SRV record/name-address table registration 803 to SRV record/name-address table 501. That is, table setting section 703 registers global IP address “GA1” of gateway apparatus 300 and selected port “xxx” in SRV record/name-address table 501.

After port mapping is performed in this way, table setting section 703 outputs port mapping request response 804 indicating that port mapping has been completed to UPnP processing section 702 and UPnP processing section 702 transfers port mapping request response 805 to host 100a.

After that, host 100a periodically transmits port mapping confirmation request 806 to gateway apparatus 300, UPnP processing section 702 of gateway apparatus 300 outputs port mapping confirmation request 807 to table setting section 703, table setting section 703 makes address transfer table reference 808 and sends back this result to UPnP processing section 702 as port mapping confirmation response 809. UPnP processing section 702 transfers port mapping confirmation response 810 to host 100a to thereby confirm whether or not port mapping is set in address transfer table 505.

The above described operation is performed when, for example, the host in private network 100 newly provides a service.

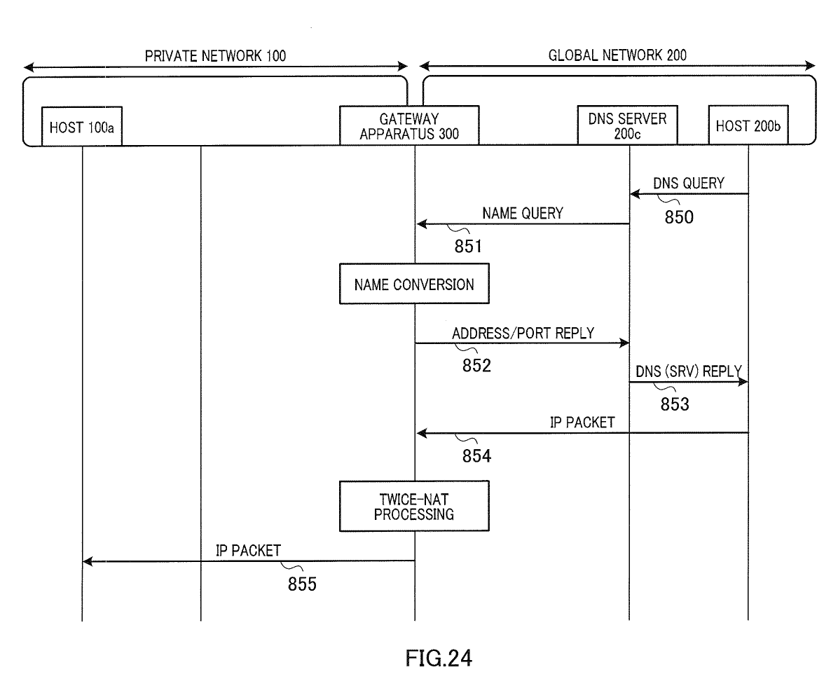

Next, access from global network 200 to private network 100 will be explained with reference to the sequence diagram shown in FIG. 24.

First, host 200b in global network 200 transmits DNS query 850 about _Service._Proto.Name “_www._tcp.private.com” to DNS server 200c in global network 200. However, since _Service._Proto.Name “_www._tcp.private.com” is not registered in DNS server 200c, name query 851 is transmitted to gateway apparatus 300.

Name query 851 is input to name resolution section 304 via global network interface section 313, reception identification section 314 and DNS message identification section 303. In this embodiment, since address transfer table 505 and SRV record/name-address table 501 are set beforehand with host 100a in private network 100 through UPnP, name resolution section 304 searches “_www._tcp.private.com” from SRV record/name-address table 501 and acquires private IP address “PA3” and private port “aaa”.

Acquired private IP address “PA3” and private port “aaa” are converted to global IP address “GA1” and global port “xxx” of gateway apparatus 300 with reference to address transfer table 505 and transmitted to DNS server 200c in global network 200 as address/port reply 852. DNS server 200c transfers DNS reply 853 indicating that the IP address of _Service._Proto.Name “_www._tcp.private.com” is global IP address “GA1” and the global port is “xxx” to host 200b. Therefore, actual private IP address “PA3” of host 100a and private port “aaa” in private network 100 are concealed from host 200b and DNS server 200c in global network 200. Host 200b then transmits IP packet 854 to gateway apparatus 300 by designating global IP address “GA4” as the sender address, global IP address “GA1” as the destination address and global port “xxx” as the destination port.

After that, Twice-NAT processing as in the case of Embodiment 2 is performed, the destination address is converted to private IP address “PA3”, the destination port is converted to private port “aaa” and the sender address is converted to private IP address “PA4” and IP packet 855 is transmitted to host 100a. Therefore, actual global IP address “GA4” of host 200b in the global network is concealed from host 100a in private network 100.

As described above, according to this embodiment, when a communication between the global network and the private network is carried out, the gateway apparatus converts the IP address which corresponds to the domain name to an unused IP address in the sender network at the time of a name resolution and also converts the sender address and the destination address to IP addresses in the network of the packet transfer destination at the time of transmission of an IP packet. It is thereby possible to prevent actual IP addresses from being exchanged beyond the mutual networks, allow access from the global network side to the private network side while maintaining security and realize intercommunication between the global network and the private network.

Furthermore, according to this embodiment, since port mapping is created at the same time as a host in the private network is started by UPnP, even if there is no DNS server in the private network, the gateway apparatus can perform a name resolution.

In the above embodiments, only the sender address is converted at the time of access from the global network to the private network and only the destination address is converted at the time of access from the private network to the global network. Therefore, in the above described respective embodiments, the number of hosts in the global network which can simultaneously access the private network depends on the number of private IP addresses available to the gateway apparatus. Furthermore, the number of hosts in the global network which can be simultaneously accessed from the private network likewise depends on the number of private IP addresses available to the gateway apparatus.

Therefore, the present invention may also be adapted so as to convert not only the sender address but also the port at the time of access from the global network to the private network. Furthermore, the present invention may also be adapted so as to convert the destination address and the port at the time of access from the private network to the global network.

In this way, the number of hosts in the global network which can be accessed from the private network or the number of hosts in the global network which can access the private network no longer depends on private IP addresses available to the gateway apparatus.

As explained above, the address transfer apparatus according to a first aspect of this embodiment is an address transfer apparatus provided between a first network in which a packet destination is included and a second network in which a packet sender is included, and adopts a configuration including a setting section that sets an address in the first network of the packet destination in association with a temporary address in the second network, a first transmission section that transmits the set temporary address to the packet sender, a conversion section that converts the destination address and the sender address of a packet transmitted from the packet sender to addresses in the first network and a second transmission section that transmits the packet after the address transfer to the packet destination.

According to this configuration, the temporary address is associated with the packet destination, the sender address and destination address of the packet transmitted from the packet sender to the temporary address are converted to addresses in the first network and then transmitted to the packet destination, and it is thereby possible to conceal the packet sender address from the packet destination and also conceal the address of the packet destination from the packet sender. Therefore, it is possible to allow access from the global network side to the private network side while maintaining security and realize intercommunication between the global network and the private network.

The address transfer apparatus according to a second aspect of this embodiment is the above described first aspect which adopts a configuration, wherein the setting section designates the temporary address as the address in the second network of the address transfer apparatus and sets a temporary port number in the second network in association with the port number of the packet destination.

According to this configuration, the temporary address is designated as the address of the address transfer apparatus and the port number is associated with the temporary port number, and it is thereby possible to identify the address according to the port number and prevent many finite addresses from being occupied.

The address transfer apparatus according to a third aspect of this embodiment is the above described second aspect which adopts a configuration, further including a reception section that receives a request message to be transmitted when the packet destination is started, for requesting the port number of the packet destination to be associated with a temporary port number in the second network, wherein the setting section sets the port number of the packet destination and the temporary port number when the request message is received.

According to this configuration, since the port number of the packet destination is associated with the temporary port number when the packet destination is started, it is possible to perform a name resolution even if the DNS server or the like is not installed in the first network.

Furthermore, the address transfer method according to a fourth aspect of this embodiment is an address transfer method between a first network in which a packet destination is included and a second network in which a packet sender is included, including: setting an address in the first network of the packet destination in association with a temporary address in the second network; transmitting the set temporary address to the packet sender; converting the destination address and the sender address of a packet transmitted from the packet sender to addresses in the first network; and transmitting the packet after the address transfer to the packet destination.

According to this method, the temporary address is associated with the packet destination, the sender address and destination address of the packet transmitted from the packet sender to the temporary address are converted to addresses in the first network and then transmitted to the packet destination, and it is thereby possible to conceal the packet sender address from the packet destination and also conceal the address of the packet destination from the packet sender. Therefore, it is possible to allow access from the global network side to the private network side while maintaining security and realize intercommunication between the global network and the private network.

The present application is based on Japanese Patent Application No. 2004-372328, filed on Dec. 22, 2004, the entire content of which is expressly incorporated by reference herein.

### INDUSTRIAL APPLICABILITY

The address transfer apparatus and the address transfer method of the present invention allow access from a global network side to a private network side while maintaining security, can realize intercommunication between the global network and the private network and are suitable for use as an address transfer apparatus and an address transfer method, for example, for a gateway between the global network and the private network.

1. An address transfer apparatus provided between a first network in which a packet destination is included and a second network in which a packet sender is included, the apparatus comprising:
a setting section that sets an address in the first network of the packet destination in association with a temporary address in the second network;
a first transmission section that transmits the set temporary address to the packet sender;
a conversion section that converts the destination address and the sender address of a packet transmitted from the packet sender to addresses in the first network; and
a second transmission section that transmits the packet after the address transfer to the packet destination.

2. The address transfer apparatus according to claim 1, wherein the setting section designates the temporary address as the address of the address transfer apparatus in the second network and sets a temporary port number in the second network in association with the port number of the packet destination.

3. The address transfer apparatus according to claim 2, further comprising a reception section that receives a request message to be transmitted when the packet destination is started, for requesting the port number of the packet destination to be associated with a temporary port number in the second network,
wherein the setting section sets the port number of the packet destination and the temporary port number when the request message is received.

4. An address transfer method between a first network in which a packet destination is included and a second network in which a packet sender is included, the method comprising:
setting an address in the first network of the packet destination in association with a temporary address in the second network;
transmitting the set temporary address to the packet sender;
converting the destination address and the sender address of a packet transmitted from the packet sender to addresses in the first network; and
transmitting the packet after the address transfer to the packet destination.
